(19) United States
(12) Patent Application Publication
(10) Pub. No.: US 2022/0081913 A1
(43) Pub. Date: Mar. 17, 2022

(54) Composite Strip Structure for Building Material

(71) Applicant: Jui-Pin Lai, Taichung City (TW)

(72) Inventor: Jui-Pin Lai, Taichung City (TW)

(21) Appl. No.: 17/019,483

(22) Filed: Sep. 14, 2020

(51) Int. Cl. E04F 15/02; B32B 7/06; B32B 7/12; B32B 5/18; B32B 27/06; B32B 27/08; B32B 25/04; B32B 25/14; B32B 27/40; B32B 27/30; E04F 15/10; E04F 15/22; E04F 15/20; E04F 13/08

(52) U.S. Cl. CPC E04F 15/02155; B32B 2307/744; B32B 7/12; B32B 5/18; B32B 27/065; B32B 27/08; B32B 25/045; B32B 25/14; B32B 27/40; B32B 27/306; E04F 15/107; E04F 15/225; E04F 15/206; E04F 13/0866; E04F 13/0887; B32B 2266/025; B32B 2250/03; B32B 2250/24; B32B 2307/56; B32B 2471/00; B32B 2607/02; B32B 2307/7265; B32B 7/06

(57) ABSTRACT

A composite strip structure includes an adhesive strip assembly and a sheet plate. The adhesive strip assembly has a sandwiched composite laminate construction and includes a PU layer, an EVA layer, a PSA layer, and an SBR layer. The PU layer is disposed at a bottom of the strip assembly and has a bottom face abutting a ground or wall. The EVA layer has a bottom face abutting a top face of the PU layer. The SBR layer is arranged between the EVA layer and the PSA layer. The PSA layer is disposed at a top of the strip assembly. The PSA layer has a bottom face abutting a top face of the SBR layer and has a top face abutting the sheet plate.

### BACKGROUND OF THE INVENTION

### 1. Field of the Invention

The present invention relates to a strip structure and, more particularly, to a composite strip structure for building material.

### 2. Description of the Related Art

A traditional plastic floor or wallboard is mounted on a ground or wall. In practice, the ground or wall is leveled previously. Then, a layer of adhesive is applied to the ground or wall. Then, the traditional plastic floor or wallboard is laid on the ground or wall by the adhesive. A solvent (rosin water or turpentine) is added into the adhesive before the adhesive is applied to the ground or wall such that the adhesive has a determined viscosity. However, the rosin water is a solvent with a toxic smell and easily causes damage to the human respiratory tract and brain nerves when evaporating in the air. Therefore, the operator must wear face masks or gas masks, thereby slowing the working time in construction, and thereby causing inconvenience to the operator. On the other side, the traditional plastic floor or wallboard is firmly secured to the ground or wall, so that after the traditional plastic floor or wallboard is removed from the ground or wall for replacement, the traditional plastic floor or wallboard cannot be reused. In addition, the traditional plastic floor or wallboard is removed from the ground or wall by a scraper so that the ground or wall us easily scratched by the scraper. Further, the adhesive remains on the ground or wall so that the operator has to level the ground or wall again, thereby causing inconvenience to the operator.

### BRIEF SUMMARY OF THE INVENTION

The primary objective of the present invention is to provide a composite strip structure that is installed rapidly and conveniently and can be reused.

In accordance with the present invention, there is provided a composite strip structure comprising an adhesive strip assembly and a sheet plate. The adhesive strip assembly has a sandwiched composite laminate construction and includes a PU (polyurethane) layer, an EVA (ethylene vinyl acetate) layer, a PSA (pressure sensitive adhesive) layer, and an SBR (styrene-butadiene rubber) layer. The PU layer is disposed at a bottom of the strip assembly. The PU layer has a bottom face abutting a ground or wall. The EVA layer is disposed at a middle of the strip assembly. The EVA layer has a bottom face abutting a top face of the PU layer. The EVA layer is made of foam material that has shock absorbing and sound eliminating effect. The SBR layer is arranged between the EVA layer and the PSA layer. The SBR layer has a bottom face abutting a top face of the EVA layer. The SBR layer is an adhesive made of rubber material that has waterproof and antiskid effect. The PSA layer is disposed at a top of the strip assembly. The PSA layer has a bottom face abutting a top face of the SBR layer. The PSA layer has a top face abutting a bottom face of the sheet plate.

According to the primary advantage of the present invention, when the PU layer of the adhesive strip assembly is adhered to the ground or wall plate, there is no pungent smell of a toxic gas arising from the rosin water (or solvent), and the user does not need to wear a gas mask during the pavement work.

According to another advantage of the present invention, the model or pattern of the composite strip structure has diverse variations according to the practical requirement during construction.

According to a further advantage of the present invention, the composite strip structure will not damage the ground, the wall plate and the surface of building material during the pavement work.

According to a further advantage of the present invention, the composite strip structure is mounted on the ground or wall plate easily, quickly and conveniently, thereby saving the working time and the manual labor. According to a further advantage of the present invention, the composite strip structure is available for all kinds of material.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partial exploded perspective view of a composite strip structure in accordance with the preferred embodiment of the present invention.

FIG. 2 is an exploded perspective view of an adhesive strip assembly of the composite strip structure in accordance with the preferred embodiment of the present invention.

FIG. 3 is a cross-sectional view of the adhesive strip assembly as shown in FIG. 2.

FIG. 4 is a schematic view showing usage of the composite strip structure in accordance with the preferred embodiment of the present invention.

FIG. 5 is a cross-sectional view of the composite strip structure in accordance with the preferred embodiment of the present invention.

### DETAILED DESCRIPTION OF THE INVENTION

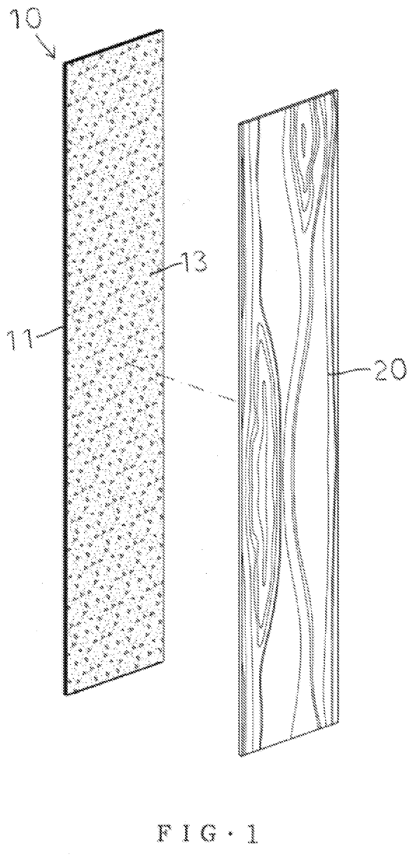

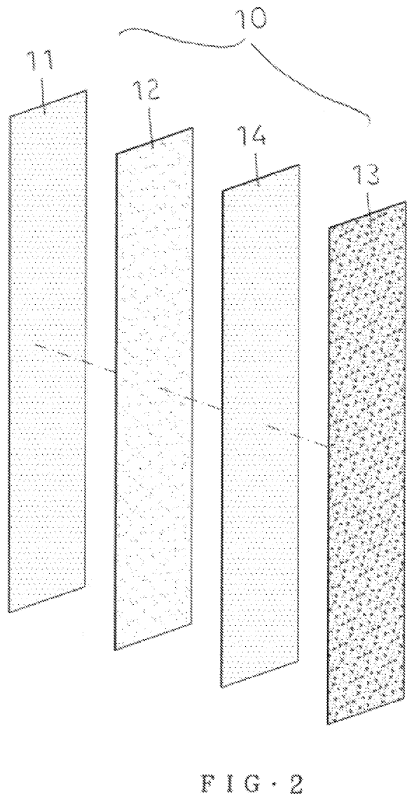

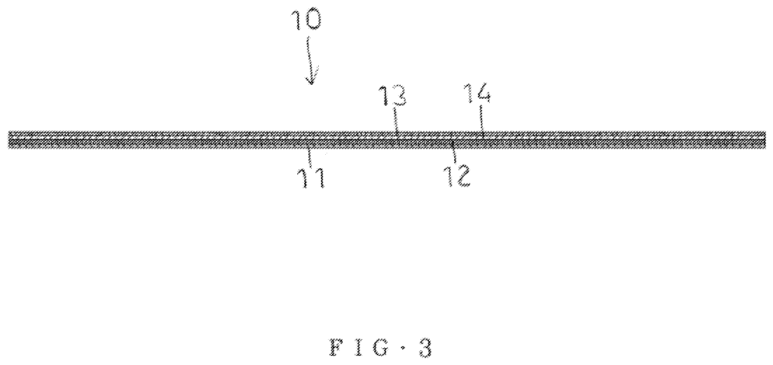

Referring to the drawings and initially to FIGS. 1-3, a composite strip structure in accordance with the preferred embodiment of the present invention comprises an adhesive strip assembly 10 and a sheet plate 20.

The adhesive strip assembly 10 has a sandwiched composite laminate construction and includes a PU (polyurethane) layer 11, an EVA (ethylene vinyl acetate) layer 12, a PSA (pressure sensitive adhesive) layer 13, and an SBR (styrene-butadiene rubber) layer 14.

The PU layer 11 is disposed at a bottom of the strip assembly 10. The PU layer 11 has a bottom face abutting a trimmed ground or wall.

The EVA layer 12 is disposed at a middle of the strip assembly 10. The EVA layer 12 has a bottom face abutting a top face of the PU layer 11. The EVA layer 12 is made of foam material that has shock absorbing and sound eliminating (or silencing) effect. The EVA layer 12 is soft and elastic and has great chemical stability. The EVA layer 12 is aging resistant, ozone resistant, and non-toxic.

The SBR layer 14 is arranged between the EVA layer 12 and the PSA layer 13. The SBR layer 14 has a bottom face abutting a top face of the EVA layer 12. The SBR layer 14 is an adhesive made of rubber material that has waterproof and antiskid effect.

The PSA layer 13 is disposed at a top of the strip assembly 10. The PSA layer 13 has a bottom face abutting a top face of the SBR layer 14. The PSA layer 13 has a top face abutting a bottom face of the sheet plate 20.

In the preferred embodiment of the present invention, the top face of the PSA layer 13 is provided with a piece of release paper to prevent the PSA layer 13 from being contaminated by dirt or dust.

In the preferred embodiment of the present invention, the PU layer 11 is made of macromolecule (or polymer) material and has a stickiness less than that of the PSA layer 13. Thus, the PU layer 11 is available for a bonding agent.

In the preferred embodiment of the present invention, the EVA layer 12 is made of ethylene vinyl acetate copolymer.

In the preferred embodiment of the present invention, the SBR layer 14 is made of styrene and butadiene copolymer.

In the preferred embodiment of the present invention, the PSA layer 13 is made of oil acrylic material and has a stickiness (or viscosity) more than that of the PU layer 11.

In the preferred embodiment of the present invention, the sheet plate 20 is a floor or a wall plate. The sheet plate 20 is waterproof and scratch resistant.

In the preferred embodiment of the present invention, the sheet plate 20 is made of plastic material with patterns formed thereon.

In the preferred embodiment of the present invention, the sheet plate 20 is made of tile material.

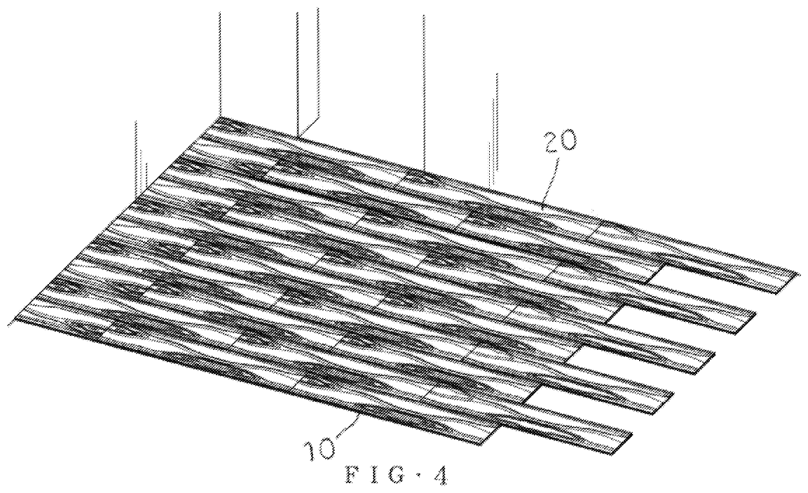

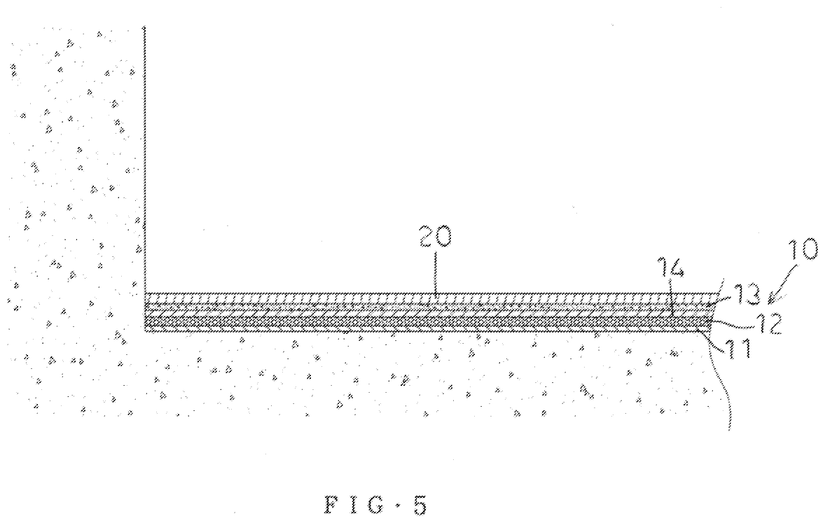

In use, referring to FIGS. 4 and 5 with reference to FIGS. 1-3, the release paper is torn and removed from the top face of the PSA layer 13. Then, the PU layer 11 of the adhesive strip assembly 10 is directly paved on the ground or wall plate. In such a manner, the PU layer 11 is affixed to the ground or wall plate by its adhesion so that the adhesive strip assembly 10 is attached to the ground or wall plate steadily. The above bonding actions are repeated, so that multiple adhesive strip assemblies 10 are bonded onto the ground or wall plate, thereby finishing the work of paving the composite strip structure.

On the contrary, when the user wishes to replace the composite strip structure, the PU layer 11 of the adhesive strip assembly 10 is directly detached from the ground or wall plate so as to remove the composite strip structure from the ground or wall plate. Thus, the composite strip structure is mounted on removed from the ground or wall plate easily, quickly and conveniently. In addition, the composite strip structure is directly removed from the ground or wall plate without damaging the ground or wall plate.

Accordingly, the composite strip structure of the present invention has the following advantages.

1. When the PU layer 11 of the adhesive strip assembly 10 is adhered to the ground or wall plate, there is no pungent smell of a toxic gas arising from the rosin water (or solvent), and the user does not need to wear a gas mask during the pavement work.

2. The model or pattern of the composite strip structure has diverse variations according to the practical requirement during construction.

3. The composite strip structure will not damage the ground, the wall plate and the surface of building material during the pavement work.

4. The composite strip structure is mounted on the ground or wall plate easily, quickly and conveniently, thereby saving the working time and the manual labor.

5. The composite strip structure is available for all kinds of material.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A composite strip structure comprising:
an adhesive strip assembly and a sheet plate;
wherein:
the adhesive strip assembly has a sandwiched composite laminate construction and includes a PU (polyurethane) layer, an EVA (ethylene vinyl acetate) layer, a PSA (pressure sensitive adhesive) layer, and an SBR (styrene-butadiene rubber) layer;
the PU layer is disposed at a bottom of the strip assembly;
the PU layer has a bottom face abutting a ground or wall;
the EVA layer is disposed at a middle of the strip assembly;
the EVA layer has a bottom face abutting a top face of the PU layer;
the EVA layer is made of foam material that has shock absorbing and sound eliminating effect;
the SBR layer is arranged between the EVA layer and the PSA layer;
the SBR layer has a bottom face abutting a top face of the EVA layer;
the SBR layer is an adhesive made of rubber material that has waterproof and antiskid effect;
the PSA layer is disposed at a top of the strip assembly;
the PSA layer has a bottom face abutting a top face of the SBR layer; and
the PSA layer has a top face abutting a bottom face of the sheet plate.

2. The composite strip structure as claimed in claim 1, wherein the top face of the PSA layer is provided with a piece of release paper.

3. The composite strip structure as claimed in claim 1, wherein the PU layer is made of macromolecule material and has a stickiness less than that of the PSA layer.

4. The composite strip structure as claimed in claim 1, wherein the EVA layer is made of ethylene vinyl acetate copolymer.

5. The composite strip structure as claimed in claim 1, wherein the SBR layer is made of styrene and butadiene copolymer.

6. The composite strip structure as claimed in claim 1, wherein the PSA layer is made of oil acrylic material and has a stickiness more than that of the PU layer.

7. The composite strip structure as claimed in claim 1, wherein the sheet plate is a floor or a wall plate.

8. The composite strip structure as claimed in claim 1, wherein the sheet plate is made of plastic material with patterns formed thereon.

9. The composite strip structure as claimed in claim 1, wherein the sheet plate is made of tile material.
